(19) United States
(12) Patent Application Publication
(10) Pub. No.: US 2012/0111169 A1
(43) Pub. Date: May 10, 2012

(54) Sheet Cutting Apparatus

(76) Inventors: Stephen J. Blalock, (US); Eckehart Zimmermann, (US)

(21) Appl. No.: 12/942,815

(22) Filed: Nov. 9, 2010

(51) Int. Cl. B26D 1/06

(52) U.S. Cl. 83/614

(57) ABSTRACT

A sheet cutting apparatus includes a dynamic housing having a plurality of fingers, also included are a plurality of steps that are oppositely disposed from the plurality of fingers, wherein each of the plurality of fingers and each of the plurality of steps are adjacent to one another forming a plurality of gaps that allow a sheet of material therethrough, while creating a tortuous path for the sheet of material. Operationally, the plurality of gaps act to keep a portion of the sheet of material taut in-between each of the plurality of gaps. Also, a cutter is disposed within the dynamic housing such that the plurality of fingers and steps are evenly disposed on opposite sides of the cutter. Operationally, the taut sheet material is cut with the ability to accommodate a non-linear cutting path in the sheet of material via selectably altering a movement path of the dynamic housing.

### TECHNICAL FIELD

The present invention relates generally to a sheet cutting apparatus. More particularly, it relates to an apparatus for cutting gift wrap paper having a dynamic clamp to hold the paper on both sides of the cutting blade in a substantially taut state, further allowing for omni-directional precision cutting without damaging the paper.

### FIELD AND BACKGROUND

Businesses and individuals alike find daily needs to cut sheet materials, whether it be for printing, faxing, wrapping, scrapbooking, fabrication, or any other similar use. Paper products are probably among the most common products needing to be cut, and precision cutting is imperative when cutting material like paper which can easily tear or fold while being cut due to its lack of compressive stiffness while typically being cut via shearing. Paper generally, and gift wrap in particular, is weak, thin, and brittle. In order to cut it, it must be held taut adjacent to the shear point, but not too taut, such as the nature of paper means that it punctures and tears easily.

Basic paper cutters may consist of no more than a base upon which the paper is placed, and a blade designed either to slide across the paper, or to cut downwards against the paper. The primary problem with paper cutters of this design is the fact that there is nothing to hold the paper steady, and the user must rely upon their own ability to hold the paper in place in order to prevent it from shifting while being cut. Even if the user is holding the paper in place, if he is not holding it close enough to the blade, the paper may still shift or become caught and bunch up in an accordion configuration, thereby damaging the paper and preventing a clean shearing cut. Furthermore, manually holding the paper close to the cutting blade raises the potential that the user might also cut his fingers, injuring himself and possibly damaging the paper with a blood stain as well. Because of this danger of injury to the user, a trend has developed to conceal the blade in a housing for safety, however this added protection does nothing to prevent the paper from shifting or and bunching up in an accordion configuration.

More advanced paper cutters feature the addition of a paper holding member located next to the cutting blade, wherein the user may hold the paper in place, applying even pressure to the entire sheet without the need to place his fingers near the cutting path of the blade. However, these cutters are not perfect either. By only holding down one edge of the paper to be cut, the loose paper that is not stabilized may still shift somewhat or accordion while being cut resulting in an imprecise cut, or damaging the paper, as the paper is only moderately taut on one side of the cutting blade, wherein the non-taut side of the paper on the opposite side of the cutting blade has a higher chance of tearing as opposed to cutting or accordion while being cut.

Furthermore, most paper cutters allow for only uni-directional, straight line cutting by incorporating a channel for the blade to cut in to, or by cutting the paper with a blade aligned to cut downwards along the edge of the base, or by utilizing a blade affixed to slide along a stationary mount. These paper cutters may also incorporate clamps on either side of the channel to hold the paper. The paper must be repositioned for each cut in a different direction, and paper that comes off of a roll is almost impossible to reposition in a paper cutter without significant hassle and likely tearing of the paper. The prior art has attempted to address some of these problems however, with each one the paper is still likely to shift or tear resulting in imprecise cutting or damage to the paper. So these channel-clamp type paper cutters do attempt to keep the paper taut adjacent to the cutting blade and provide a measure of safety as the cutting blade is disposed within the channel and away from the user's fingers, however as stated before this type of cutter can only cut in one direction, being limited in flexibility due to the fixed channel and adjacent clamps. Also these channel paper cutters can have a gift wrap paper curling problem due to the thin nature of this paper when the channel is elevated in relation to its surrounding surface.

First in the prior art, U.S. Pat. No. 5,671,647 to Mori discloses a paper cutter comprising: a bed for placing paper to be cut thereon; a rail mounted on said bed; a slider made slidable along said rail; and a rotary blade carried by said slider for cutting the paper as said slider is moved, the rail having springs for supporting the two ends of said rail there through on the bed so that the rail may move up and down, and wherein the rail has its lower face formed on its end edge with a cutting position determining face such that the slider is fitted on the rail in a position where the rotary blade runs along the positioning face. With the construction specified above, in Mori ‘647 the present invention has the following operation, in the paper cutter of the type in which the paper is placed on the bed so that it is cut by the rotary blade carried by the slider while moving the slider along the rail mounted on the bed, the rail has its two ends so supported over the bed through the springs as to move up and down. As a result, in Mori '647 the rail itself is supported to float over the bed, further, the rail in the floating state is depressed by the depression of the slider when the paper is to be cut, so that the paper can be clamped under pressure only at the portion to be cut between the rail and the bed in accordance with the movement of the slider.

Because the rotary blade in Mori '647 exerts force on the paper primarily in a direction perpendicular to the bed, a negligible displacement of the paper occurs even if the paper is partially clamped under pressure at its portion to be cut between the rail and the bed, in contrast, a non-rotary blade produces significant force in the cutting direction, which produces a moment between the cutting force and the holding force of the rail. Moreover, in Mori '647 the rail has its lower face formed on its end edge with the cutting positioning face, and the slider is fitted on the fall at the portion where the rotary blade runs along the positioning face, so that the cutting position can be easily determined by lowering the rail supported in the floating state by the positioning face formed on the rail, at the same time, the rotary blade can cut the paper at the determined position because it is positioned along the positioning face, see column 1, lines 62-67, and column 2, lines 1-19. However, Mori '647 lacks again the flexibility to do anything other than a single one way cut.

Additionally, U.S. Pat. No. 7,249,547 to Mori, et al. discloses a paper cutter, wherein to-be-cut paper placed on a base is press-held by a straight-rod-like paper holding member, which is supported on the base and is vertically movable; and the to-be-cut paper is cut with moving a cutting blade along the paper holding member. In Mori '547 a four-joint link array mechanism is provided, each of the four-joint link array mechanisms comprising a first pivotal link swingably supported on a side of a final cutting position of the base, a second pivotal link swingably supported on a side of a cutting starting position of the base, and a connecting link rotatably supported between a free end of the first pivotal link and a free end of the second pivotal link. Also, in Mori '547 the second pivotal link is attached to the paper holding member along a face on a side opposite to a pressing face of the paper holding member; and the paper holding member is moved in a same direction with a moving direction of the cutting blade; the four-joint link array mechanisms include first and second four-joint link array mechanisms disposed in parallel along the paper holding member.

With the first and second pivotal links in Mori '547 adjacent between the respective four-joint link array mechanisms are disposed to intersect with each other and to be slanted in directions opposite each other; and in association with pivotal movements of the first and second pivotal links disposed to intersect with each other, the respective four-joint link array mechanisms move the respective connecting links in opposition to each other in a longitudinal direction, see claim 1. Mori '547 answers the problem of paper shifting while being cut by providing a paper holding member, however, it does not teach any manner of holding the paper taut while cutting to prevent the paper from bunching up, nor does it teach any manner of cutting the paper in different directions without repositioning the paper.

Next in the prior art, U.S. Pat. No. 6,786,123 to Chen discloses a portable precision cutting device comprising: a cutting board, at both sides of which is formed with a mounting portion, each mounting portion being concavely formed, and at an inner side of the each mounting portion being defined with a recess, a channel formed at a top surface corresponding to the two mounting portions, in the channel being provided with plural magnets; a cutting-resistant pad formed in accordance with the shape of the channel so as to be accommodated in the channel of the cutting board. Further, in Chen provided are plural fasteners serving to prevent disengagement of the cutting-resistant pad from the channel, the cutting-resistant pad including two cutting portions and spaced apart by a plurality of openings defined therebetween, the openings being located corresponding to the magnets; a pressing member including a piece of bar and two coupling portions formed at both sides thereof. In Chen, the two coupling portions having legs formed thereof while the bar having a groove formed at one side, the legs in the coupling portion of the pressing member serving to engage with the corresponding recesses in the mounting portions of the cutting board, whereby the pressing member can be engaged with the cutting board for raising and lowering movement.

Also in Chen under the bar is adhered an iron sheet for magnetic attraction with the magnets in the channel; a cutting mechanism provided on its frame with an elastic plate and an engaging portion respectively, a roller blade and a shield disposed at a side of the cutting mechanism, the cutting mechanism movably mounted on the pressing member by virtue of the engaging portion engaged with the bar, and the elastic plate employed to resiliently abut against the bar, a limiting pin preferably disposed at an end of the bar of the pressing member for preventing disengagement of the cutting mechanism from the bar, see claim 1 Like Mori '547, Chen answers the problem of paper shifting while being cut by providing a magnetic pressing member and magnetic channel. However, as shown by Chen FIG. 3, the cutting blade slides along the outside of the pressing member and there is nothing to hold the excess paper steady. Though Chen holds part of the paper steady, the portion that is being cut off could still become caught on the blade and accordion, ruining the piece being cut. And again, like Mori '547, Chen does not allow for omni-directional cutting, and the paper must be repositioned for each cut in a different direction

Furthermore, U.S. Pat. No. 5,613,415 to Sanpei discloses a paper cutting apparatus comprising an elongated fixed blade, a movable blade which reciprocates along the fixed blade in the direction of width of paper to cut the paper in cooperation with the fixed blade, a fixed member arranged midway along a path of the movable blade, a pair of paper holding members, movably arranged on two sides of the fixed member for alternately holding a cut end portion of the paper cut by the movable blade, and coupling means for detachably coupling the movable blade and the paper holding members with a predetermined coupling force. Further, in Sanpei a canceling coupling is between the movable blade and one of the paper holding members by using the fixed member, while coupling the movable blade and the other of the paper holding members during movement of the movable blade in a paper cutting operation, see column 1, lines 45-61. The object of the invention in Sanpei being to allow for a reduction in size of an apparatus in which the cutting apparatus is mounted as well as providing an apparatus which imposes no limitation on its place of installation, see Sanpei, column 1, lines 39-44. Sanpei further teaches two holding members that hold cut paper, yet these members only hold paper after it is cut, and do not hold the paper taut for precision cutting. Like Mori '647, Sanpei leaves open the possibility that the paper may shift or accordion while it is being cut.

Continuing in the prior art, U.S. Pat. No. 5,303,626 to Uehara, et al. discloses a cutting apparatus wherein an article to be cut is held by a frame and the article is cut by shifting a plurality of cutter members for cutting the article. During the cutting of the article, in Uehara et al., the cutter members are shifted without being aligned in a line perpendicular to advancing directions of the cutter members, with this arrangement, since the article to be cut is cut by the plurality of cutter members mounted on the frame, it is possible to cut the article correctly in a short time. Further, in Uehara et al., during the cutting of the article, since the cutter members can be shifted without being aligned in a line perpendicular to advancing directions thereof, it is possible to cut the article such that the cut edge of the article after cutting is removed in a transverse or widthwise direction, see Column 1, lines 35-50. Again, however, like the holding members taught in Chen or Mori '547, the holding member in Uehara, et al., does not hold the paper taut, nor does it hold the paper on both sides of the cutting members to prevent the paper from bunching up.

Further in the prior art, U.S. Pat. No. 4,210,043 to Urion, et al. discloses a cutting assembly usable for severing strong, flexible sheet materials which tend to stretch or flex into discrete elements. Urion, et al. teaches a cutter slide with a top wall overlying the cutting element, see Urion, et al., Column 2, lines 66-67. This top in the Urion wall includes means to force a section of the sheet against the track as the cutter slide is moved, thereby immobilizing the sheet, and another means to tension the sections to be cut into a taut condition prior to cutting, see Urion, et al., column 2, lines 67-68, column 3, lines 1-7. Urion, et al. further features sharp edges at number 36 of FIG. 3, and a series of serrations or grooves on the upper surfaces creating spaced-apart points, as shown by numbers 32 and 36 of FIG. 2, designed to aid in immobilizing the sheet to be cut. In Urion, namely points 36 and 37 (see FIGS. 2 and 3) further, referring specifically to column 6, line 55 through column 7, line 35, these points are to bite into the sheet material to create an “immobilized engagement” (see also claim 1) in an “elastic strong sheeting” which could hardly describe paper, as paper is not elastic nor strong, plus thus biting into the paper would destroy any intended effect of a clean cut by having a number of puncture marks for 4 different lines (2 per side). In Urion, et al. the design could only possibly work with sheet materials that are strong and tending to stretch, as these design features would puncture or tear a material that is neither strong nor tending to stretch such as a sheet of paper.

The prior art has simply not solved the problems encountered while cutting paper; paper still shifts resulting in imprecise cuts, it still accordions and bunches up tearing the paper and interfering with the motion of a blade sliding on a track, and the user still must reposition the paper each time a cut in a different direction is desired. What is needed in the present invention is a dynamic clamp to keep the paper from being either forced down or lifted up while cutting depending on the direction of the blade, that also keeps the paper taut so that the blade may engage the paper and perform a clean, crisp cut without damaging the paper, and further, prevents the paper from interfering with the sliding action of the cutting device. Furthermore, the present invention should restrain the paper on both sides of the cutter and in either direction of the bilateral cut, and be capable of omni-directional cutting.

### BRIEF DESCRIPTION OF DRAWINGS

FIG. 1 shows a perspective view of the sheet cutting apparatus showing the lengthwise axis, the dynamic housing, the plurality of fingers, the plurality of steps, the plurality of gaps, the rotational axis, and rotational movement of the dynamic housing;

FIG. 2 shows an exploded perspective view in relation to the means for cutting to the sheet cutting apparatus, showing the lengthwise axis, the dynamic housing, the plurality of fingers, the plurality of steps, the plurality of gaps, and the rotational axis;

FIG. 3 shows a side elevation view of the sheet cutting apparatus showing the lengthwise axis, the dynamic housing, the plurality of fingers, the plurality of steps, the plurality of gaps, and the rotational axis;

FIG. 4 shows cross section 4-4 from FIG. 3 of the sheet cutting apparatus for the dynamic housing showing in detail the lengthwise axis, plurality of fingers, plurality of steps, plurality of gaps, showing the tortuous path for the sheet material, wherein the plurality of fingers and the plurality of steps are evenly disposed of opposite side of the means for cutting in the form of a blade, also shown is the finger thickness, the equal increment ascending gaps and the equal increment descending gaps, along with the gap distance, the radius of increment transition, the corner radius of finger termination, with the finger extensions and terminations, plus the neck member, the head portion, and the exterior portion of the dynamic housing;

FIG. 5 shows cross section 5-5 from FIG. 4 of the sheet cutting apparatus of the dynamic housing, showing in detail the lengthwise axis, the plurality of fingers, the plurality of steps, the plurality of gaps, the means for cutting in the form of a blade with the cutting edge of the blade shown, and the angle of the cutting edge;

FIG. 6 shows a perspective view of the static beam having the features of the longwise axis, the first face portion of the beam, the second face portion of the beam, the channel of the beam, the plurality of shoulders of the beam, and the ridges of the beam;

FIG. 7 shows cross section 7-7 of FIG. 6 for the static beam, having the features of the longwise axis, the first face portion of the beam, the second face portion of the beam, the channel of the beam, the plurality of shoulders of the beam, and the ridges of the beam;

FIG. 8 shows cross section 8-8 from FIG. 9 showing the detail of the slidable engagement of the dynamic housing to the static beam, that includes the sheet cutting apparatus, the lengthwise axis, the neck member, the head portion, the exterior portion of the dynamic housing, also shown is the longwise axis, the first face portion of the beam, the second face portion of the beam, the channel of the beam, the plurality of shoulders of the beam, and the ridges of the beam;

FIG. 9 shows the perspective view of the cross section in FIG. 8 of the slidable engagement of the dynamic housing to the static beam, that includes the sheet cutting apparatus, the lengthwise axis, the plurality of fingers, the plurality of gaps, the plurality of steps, also shown is the longwise axis, the first face portion of the beam, the second face portion of the beam, the channel of the beam, the plurality of shoulders of the beam, and the ridges of the beam, the slidable movement of the dynamic housing to the static beam along with the movement path of the dynamic housing;

FIG. 10 shows the use view of FIG. 9 with the sheet of material being cut with the slidable movement of the dynamic housing to the static beam along with the movement path of the dynamic housing cutting through the sheet of material substantially along the lengthwise axis, with FIG. 10 also showing slidable engagement of the dynamic housing to the static beam, that includes the sheet cutting apparatus, the lengthwise axis, the plurality of fingers, the plurality of gaps, the plurality of steps, also shown is the longwise axis, the first face portion of the beam, the second face portion of the beam, the channel of the beam, the plurality of shoulders of the beam, and the ridges of the beam;

FIG. 11 shows cross section 11-11 from FIG. 10, also being similar to FIG. 4, with FIG. 11 primarily showing the sheet cutting apparatus dynamic housing with the detail of the sheet of material engaging upon the tortuous path interfacing with the plurality of fingers, the plurality of steps, the plurality of gaps, causing a portion of the sheet of material to be substantially taut, further the lengthwise axis, and the means for cutting in the form of a blade; and

FIG. 12 shows a use perspective view of the sheet cutting apparatus similar to FIG. 10 except without the use of the static beam which allows the dynamic housing to take a non-linear cutting movement path through the sheet of material with rotation of the dynamic housing about the rotational axis having rotational movement, also shown is the lengthwise axis, the plurality of fingers, the plurality of steps, and the plurality of gaps.

### SUMMARY OF INVENTION

The present invention is a sheet cutting apparatus, for cutting a sheet of material that includes a dynamic housing having a lengthwise axis wherein a plurality of fingers project therefrom, wherein the fingers are positioned substantially parallel to the lengthwise axis. Further included in the dynamic housing is a plurality of steps that are oppositely disposed from the plurality of fingers, wherein each of the plurality of fingers and each of the plurality of steps are adjacent to one another forming a plurality of gaps. Wherein each of the plurality of gaps are sized and configured to dynamically allow the sheet of material therethrough, while creating a tortuous path for the sheet of material perpendicular to the lengthwise axis. Wherein operationally the plurality of gaps act to keep a portion of the sheet of material substantially taut in-between each of the plurality of gaps.

Further included in the sheet cutting apparatus is a means for cutting disposed within the dynamic housing along the lengthwise axis, the means for cutting is disposed such that the plurality of fingers and the plurality of steps are evenly disposed on opposite sides of the means for cutting. Wherein operationally, the portion of the sheet material substantially taut is to be cut via the means for cutting that cuts through the sheet material substantially along the lengthwise axis with the ability to accommodate a non-linear cutting path in the sheet of material via selectably altering a movement path of the dynamic housing.

### REFERENCE NUMBERS IN DRAWINGS

50 Sheet cutting apparatus
55 Dynamic housing
60 Lengthwise axis
65 Plurality of fingers
70 Plurality of steps
75 Plurality of gaps
80 Torturous path wherein the sheet of material 250 is perpendicular to the lengthwise axis 60
85 Plurality of fingers 65 and plurality of steps 70 that are evenly disposed on opposite sides of the means 155
90 Thickness of each finger
91 First void distance between the plurality of fingers
92 Second void distance between the plurality of fingers
95 Gaps ascending
100 Gaps ascending in equal increments
105 Gaps descending
110 Gaps descending in equal increments
115 Gap distance
120 Radius of increment transition 100 and 110
125 Corner radius at the finger termination 135
130 Extension of the finger 65
135 Termination of the finger 65
140 Neck member
145 Head portion
150 Exterior portion of the dynamic housing 55
155 Means for cutting
160 Blade for means 155
165 Cutting edge of blade 160
170 Angle of cutting edge 165
175 Cutting through the sheet material 250 substantially along the lengthwise axis 60
180 Non-linear cutting path through the sheet material 250
185 Static beam
190 Longwise axis of the static beam 185
195 First face portion of the static beam 185
200 Second face portion of the static beam 185
205 Channel of the static beam 185
210 Plurality of shoulders of the static beam 185
215 Ridges of the static beam 185
220 Slidable engagement of the dynamic housing 55 to the static beam 185
225 Slidable movement of the dynamic housing 55 to the static beam 185
230 Dynamic engagement of the channel portion 205 and the plurality of shoulders 210
235 Rotational axis of the dynamic housing 55
240 Rotational movement of the dynamic housing 55
245 Movement path of the dynamic housing 55
250 Sheet of material
255 Portion of the sheet material 250 substantially taut in between each of the plurality of gaps 75
256 Entrance point of the sheet material 250 into the tortuous path 80
260 Distance along lengthwise axis 60 for the sheet of material 250 lead in entrance point 256 for tautness 255 to the means 155 for cutting

### DETAILED DESCRIPTION

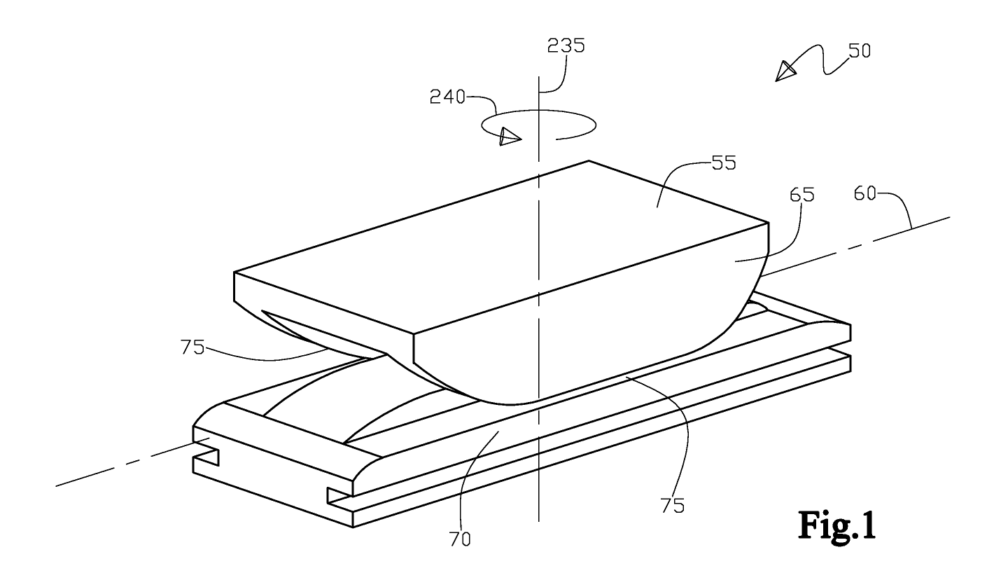

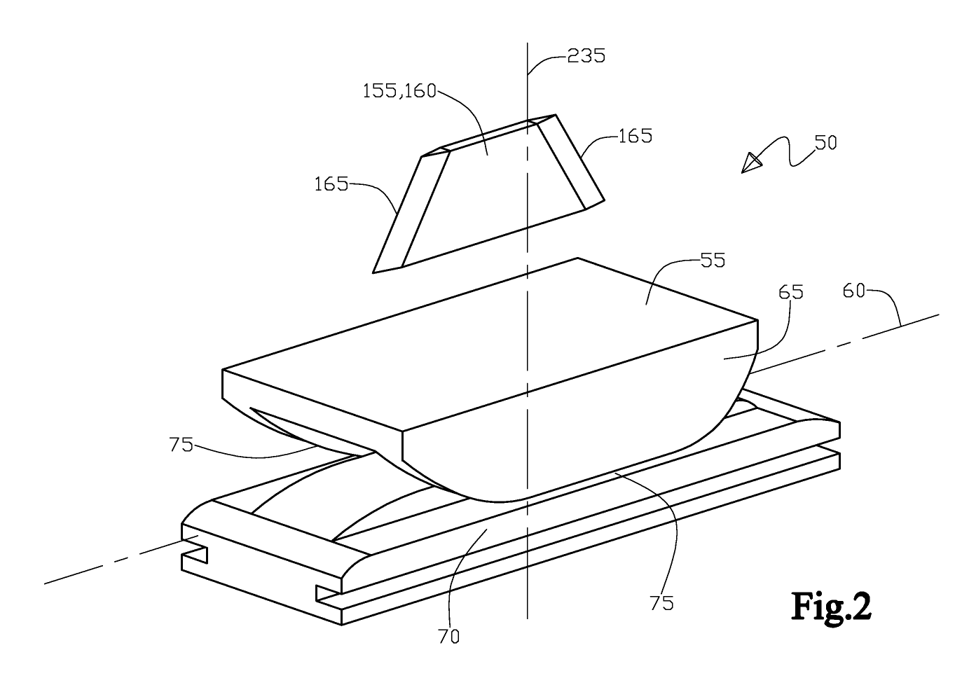

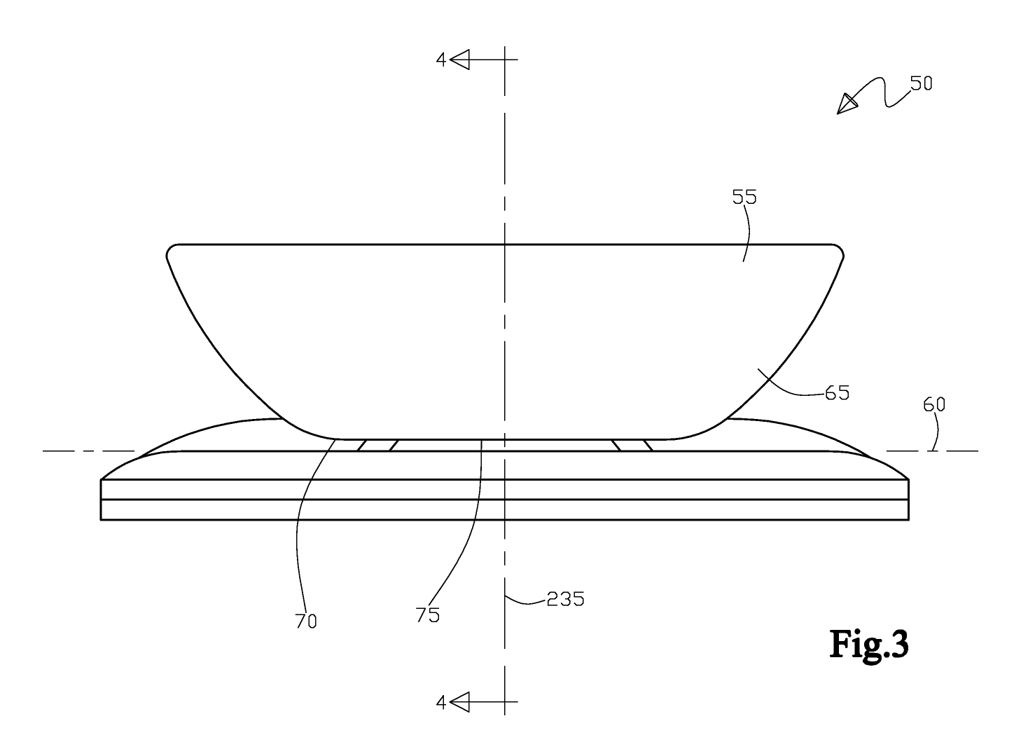

With initial reference to FIG. 1 shown is a perspective view of the sheet cutting apparatus 50 showing the lengthwise axis 60, the dynamic housing 55, the plurality of fingers 65, the plurality of steps 70, the plurality of gaps 75, the rotational axis 235, and rotational movement 240 of the dynamic housing 55. Continuing, FIG. 2 shows an exploded perspective view of the sheet cutting apparatus 50 in relation to the means 155 for cutting to the sheet cutting apparatus 50, showing the lengthwise axis 60, the dynamic housing 55, the plurality of fingers 65, the plurality of steps 70, the plurality of gaps 75, and the rotational axis 235. Further, FIG. 3 shows a side elevation view of the sheet cutting apparatus 50 showing the lengthwise axis 60, the dynamic housing 55, the plurality of fingers 65, the plurality of steps 70, the plurality of gaps 75, and the rotational axis 235.

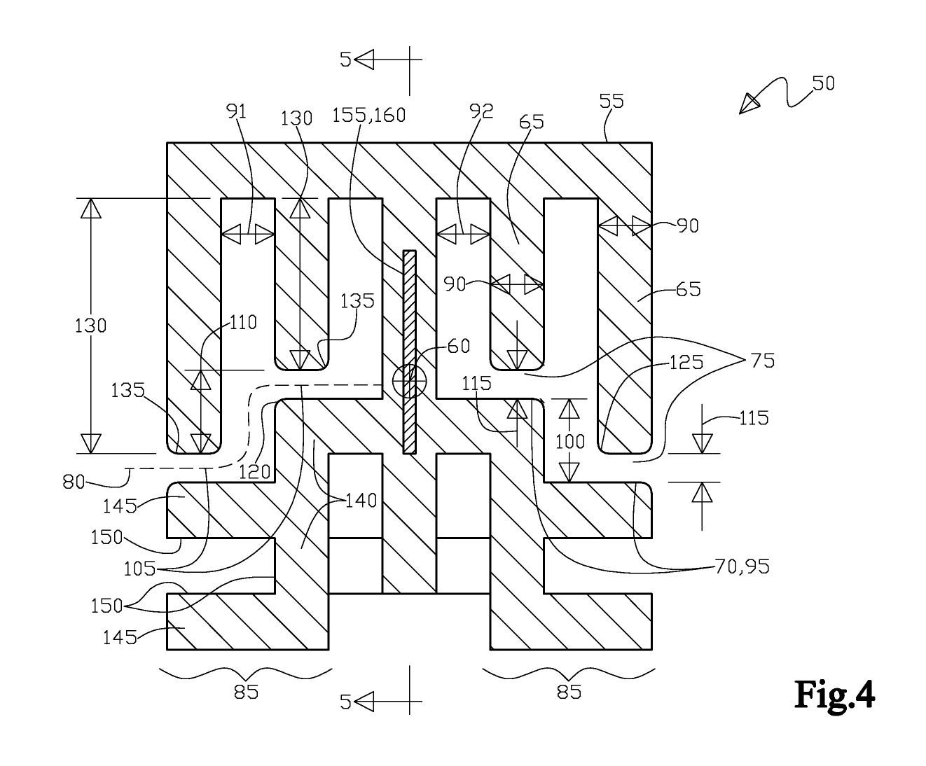

Next, FIG. 4 shows cross section 4-4 from FIG. 3 of the sheet cutting apparatus 50 for the dynamic housing 55 showing in detail the lengthwise axis 60, the plurality of fingers 65, the plurality of steps 70, the plurality of gaps 75, showing the tortuous path 80 for the sheet material 250. Wherein FIG. 4 shows the plurality of fingers 65 and the plurality of steps 70 that are evenly disposed 85 of opposite side of the means 155 for cutting in the form of a blade 160, also shown in the finger thickness 90, the equal increment 100 ascending 95 and the equal increment 110 descending 105 gaps. Also shown in FIG. 4 is the gap 115 distance, the radius 120 of increment transition, the corner radius 125 of finger termination, with the finger extension 130 and termination 135, plus the neck member 140, the head portion 145, and the exterior portion 150 of the dynamic housing 55. Further shown in FIG. 4 is the first void distance 91 between the plurality of fingers 65 and the second void distance 92 between the plurality of fingers 65.

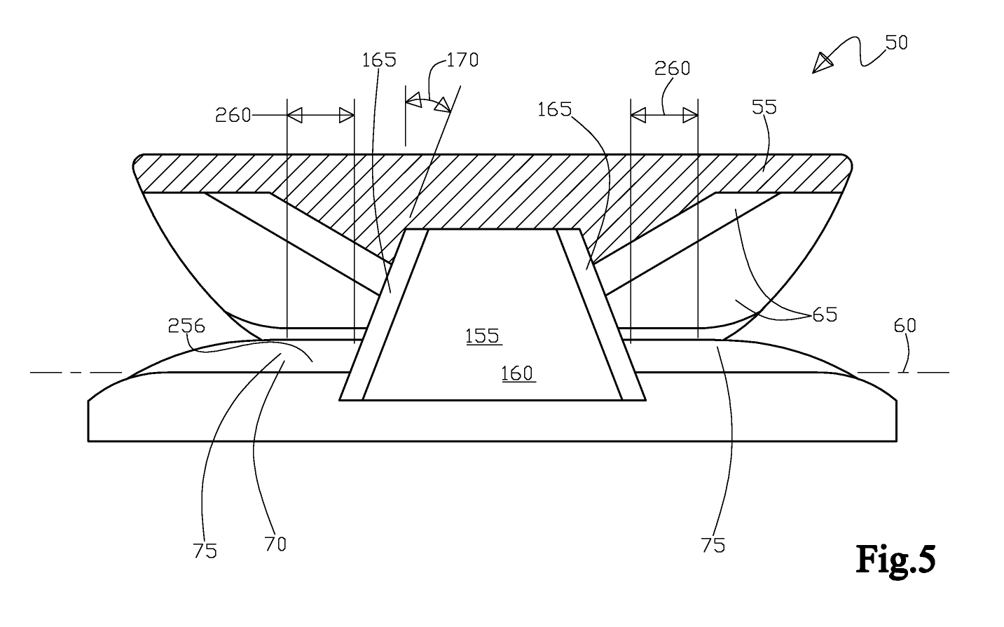

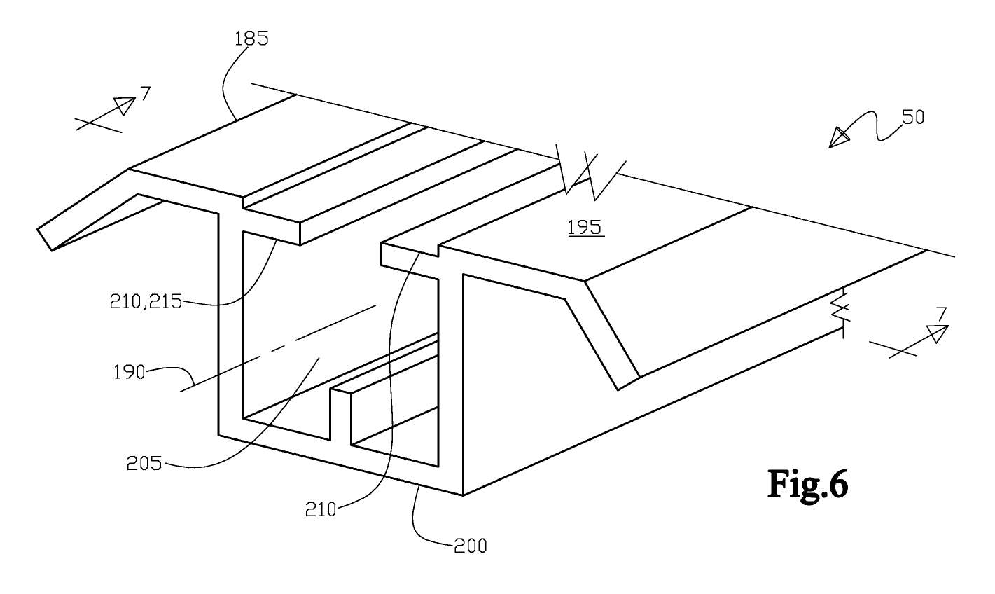

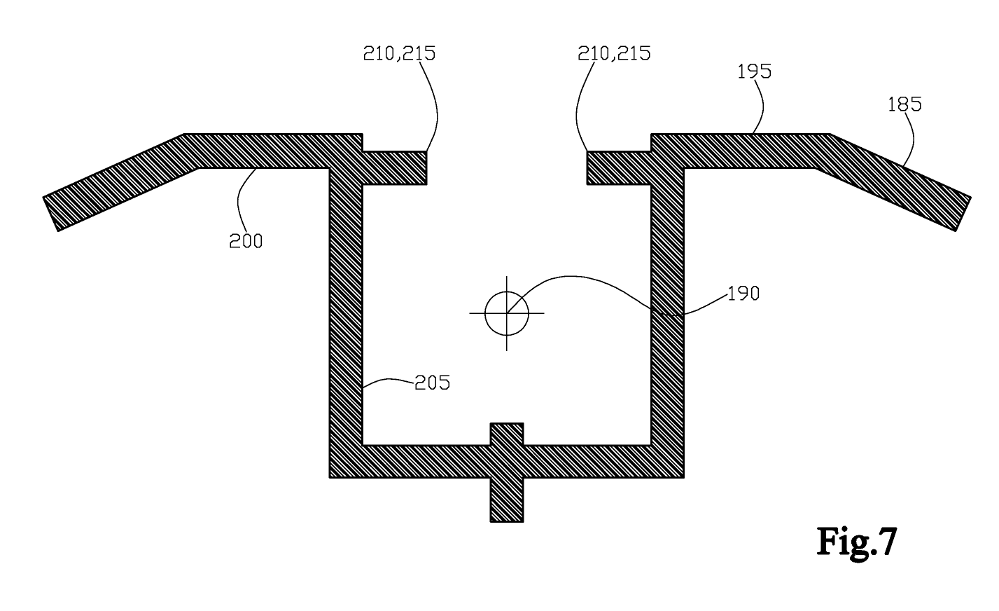

Yet further, FIG. 5 shows cross section 5-5 from FIG. 4 of the sheet cutting apparatus 50 of the dynamic housing 55, showing in detail the lengthwise axis 60, the plurality of fingers 65, the plurality of steps 70, the plurality of gaps 75, the means 155 for cutting in the form of a blade 160 with the cutting edge 165 of the blade 160 shown, and the angle 170 of the cutting edge 165. Continuing, FIG. 6 shows a perspective view of the static beam 185 having the features of the longwise axis 190, the first face portion 195 of the beam, the second face portion 200 of the beam 185, the channel 205 of the beam, the plurality of shoulders 210 of the beam, and the ridges 215 of the beam. Next, FIG. 7 shows cross section 7-7 of FIG. 6 for the static beam 185, having the features of the longwise axis 190, the first face portion 195 of the beam, the second face portion 200 of the beam, the channel 205 of the beam, the plurality of shoulders 210 of the beam, and the ridges 215 of the beam.

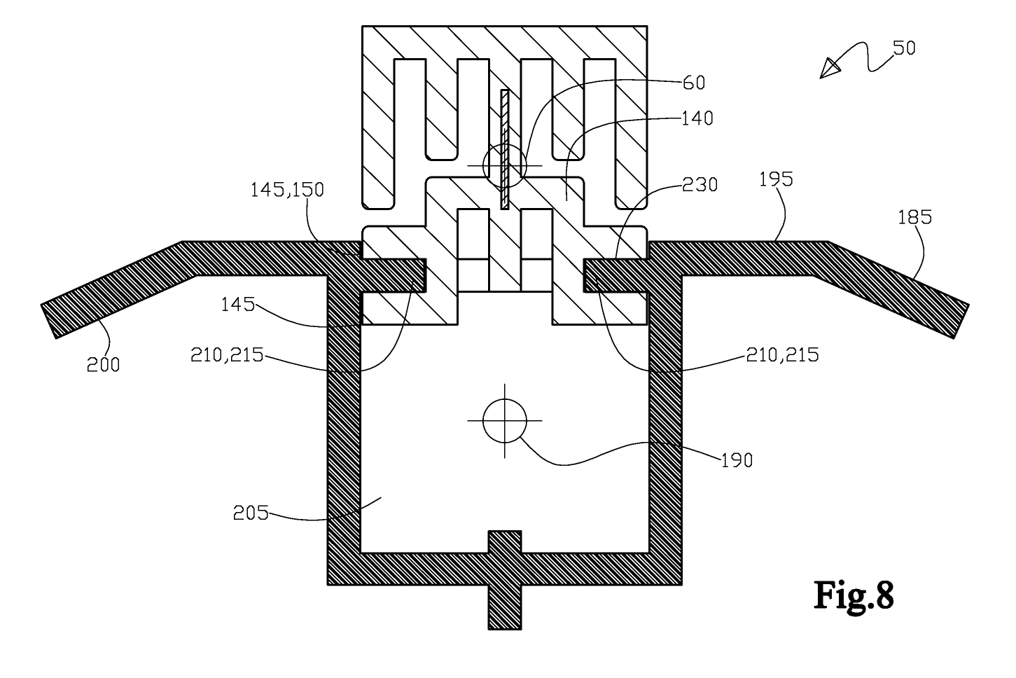

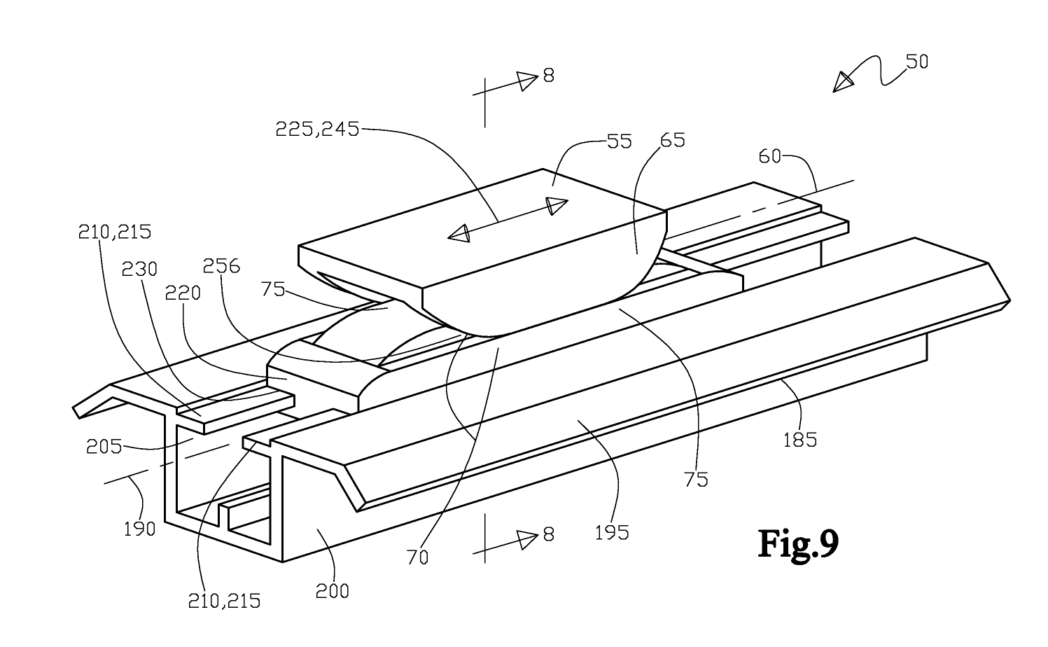

Continuing, FIG. 8 shows cross section 8-8 from FIG. 9 showing the detail of the slidable engagement 220 of the dynamic housing 55 to the static beam 185, that includes the sheet cutting apparatus 50, the lengthwise axis 60, the neck member 140, the head portion 145, the exterior portion 150 of the dynamic housing 55. Also shown in FIG. 8 is the longwise axis 190, the first face portion 195 of the beam, the second face portion 200 of the beam, the channel 205 of the beam, the plurality of shoulders 210 of the beam, and the ridges 215 of the beam. Next, FIG. 9 shows the perspective view of the cross section in FIG. 8 of the slidable engagement 220 of the dynamic housing 55 to the static beam 185, that includes the sheet cutting apparatus 50, the lengthwise axis 60, the plurality of fingers 65, the plurality of gaps 75, the plurality of steps 70, also shown is the longwise axis 190, the first face portion 195 of the beam, the second face portion 200 of the beam, the channel 205 of the beam, the plurality of shoulders 210 of the beam, and the ridges 215 of the beam, the slidable movement 225 of the dynamic housing 55 to the static beam 185, the dynamic engagement 230 of the channel portion 205 and the plurality of shoulders 210 along with the movement path 245 of the dynamic housing 55.

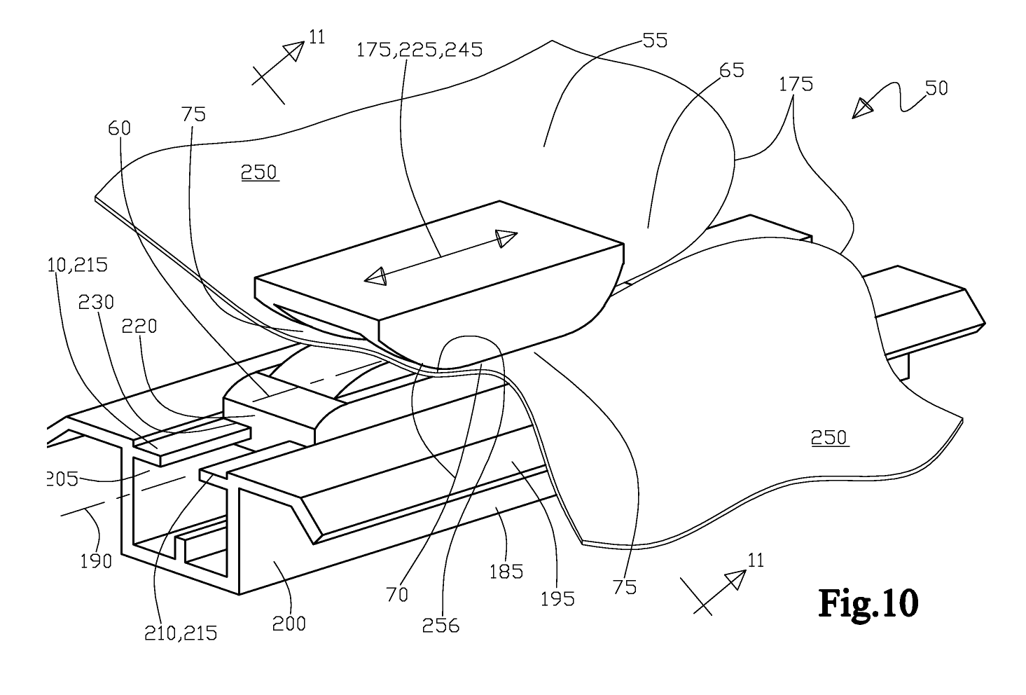

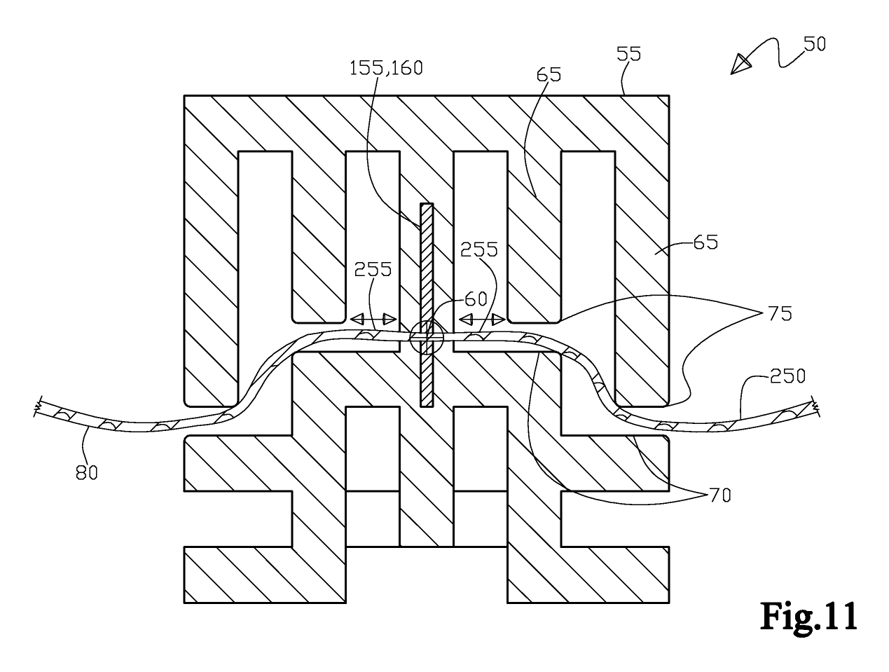

Further, FIG. 10 shows the use view of FIG. 9 with the sheet of material 250 being cut 175 with the slidable movement 225 of the dynamic housing 55 to the static beam 185 along the movement path 245 of the dynamic housing 55 cutting 175 through the sheet of material 250 substantially along the lengthwise axis 60. With FIG. 10 also showing slidable engagement 220 of the dynamic housing 55 to the static beam 185, that includes the sheet cutting apparatus 50, the lengthwise axis 60, the plurality of fingers 65, the plurality of gaps 75, the plurality of steps 70, also shown is the longwise axis 190, the first face portion 195 of the beam, the second face portion 200 of the beam, the channel 205 of the beam, the plurality of shoulders 210 of the beam, and the ridges 215 of the beam. Continuing, FIG. 11 shows cross section 11-11 from FIG. 10, also being similar to FIG. 4, with FIG. 11 primarily showing the sheet cutting apparatus 50 dynamic housing 55 with the detail of the sheet of material 250 engaging upon the tortuous path 80 interfacing with the plurality of fingers 65, the plurality of steps 70, the plurality of gaps 75, causing a portion of the sheet of material 250 to be substantially taut 255, further the lengthwise axis 60, and the means 155 for cutting in the form of a blade 160.

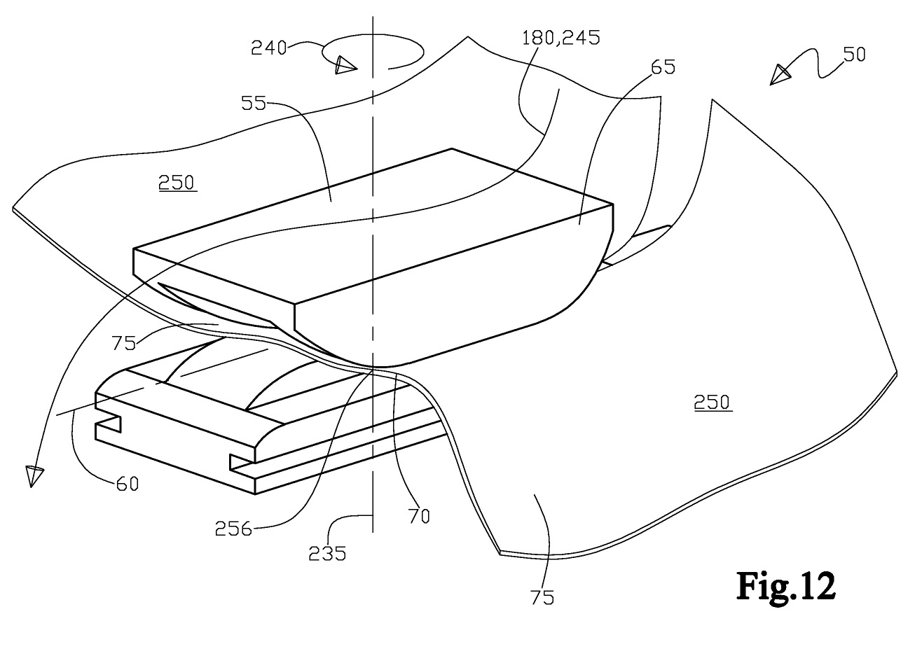

Subsequently, FIG. 12 shows a use perspective view of the sheet cutting apparatus 50 similar to FIG. 10 except without the use of the static beam 185 which allows the dynamic housing 55 to take a non-linear cutting movement 180 path through the sheet of material 250 with rotation 240 of the dynamic housing 55 about the rotational axis 235 having rotational movement 240, also shown is the lengthwise axis 60, the plurality of fingers 65, the plurality of steps 70, and the plurality of gaps 75.

With reference to FIGS. 1 through 5, the present invention is a sheet cutting apparatus 50, for cutting a sheet of material 250 that includes a dynamic housing 55 having a lengthwise axis 60 wherein a plurality of fingers 65 project therefrom, wherein the fingers 65 are positioned substantially parallel to the lengthwise axis 60. Further included in the dynamic housing 55 is a plurality of steps 70 that are oppositely disposed from the plurality of fingers 65, wherein each of the plurality of fingers 65 and each of the plurality of steps 70 are adjacent to one another forming a plurality of gaps 75, see in particular FIG. 4. Wherein each of the plurality of gaps 75 are sized and configured to dynamically allow the sheet of material 250 therethrough, while creating a tortuous path 80 for the sheet of material 250 perpendicular to the lengthwise axis 60. Wherein operationally the plurality of gaps 75 act to keep a portion of the sheet of material 250 substantially taut 255 in-between each of the plurality of gaps 75, see FIG. 11 in particular. The preferred material of construction for the dynamic housing 55 include moldable plastics such as ABS, PVC, Polystyrene, High-Molecular Polyethylene, and other thermoplastics or any suitable functional alternatives for the dynamic housing 55. Further, the sheet of material 250 is typically paper or any like sheet material.

Looking to FIGS. 2, 4, 5, and 11 especially, further included in the sheet cutting apparatus 250 is a means 155 for cutting disposed within the dynamic housing 55 along the lengthwise axis 60, the means 155 for cutting is disposed such that the plurality of fingers 65 and the plurality of steps 70 are evenly disposed 85 on opposite sides of the means 155. Wherein operationally, the portion of the sheet material 250 substantially taut 255 is to be cut via the means 155 for cutting 175 that cuts through the sheet material 250 substantially along the lengthwise axis 60 with the ability to accommodate a non-linear cutting path 180 in the sheet of material 250 via selectably altering a movement path 245 of the dynamic housing 55, see FIG. 12.

Referring back to FIGS. 4 and 11, based upon experimental testing upon the sheet of material 250 engaging the tortuous path 80 for the degree of tautness 255 in using the below mentioned preferred dimensions for gaps 75, ascending 95, descending 105, distance 115, thickness 90, gap 115, ascend 100, descend 110, and radius 120, the tautness 255 is about two ounces of lateral force for conventional letter paper having a thickness of about three-thousandths (0.003) of an inch, and the tautness 255 is about one ounce of lateral force for gift wrapping paper having a thickness of about two-thousandths (0.002) of an inch. However the gift wrap paper having glossy-smooth surface finish as compared to the conventional letter paper. One important issue, is that the tautness 255 is below the tensile failure limit (measuring the same lateral force of the paper 250, so that the sheet material 250 does not fail (tear) prematurely in the tortuous path 80 as the sheet is feed through the dynamic housing 55. Further based on experimental testing the tensile failure limit for the conventional letter paper sheet 250 was a tautness of about six ounces of lateral force and about three ounces of lateral force for the gift wrap sheet 250, thus we are at a safety factor of about 3 (six ounces divided by two ounces) for the conventional letter paper sheet 250 and at a safety factor of about 3 (three ounces divided by one ounce) also for the gift wrap paper sheet 250 for the tautness 255 risking tearing the sheet material 250 prematurely, which is acceptable. Further in looking at FIG. 5, the axial length 260 along the lengthwise axis 60 of the tortuous path 80 is preferably about six millimeters, with the axial length 260 defined as the sheet material 250 entrance point 256 to the means 155 for cutting as the length 260 is measured along the lengthwise axis 60.

Further on the sheet cutting apparatus 50 for cutting a sheet of material 250, and referencing in particular FIG. 4, it can be seen that the gaps 75 are ascending 95 on one side of the means for cutting 155 and the gaps 75 are descending 105 on an opposing side of the means for cutting 155, wherein the ascending gaps 95 and the descending gaps 105 are in relation to the lengthwise axis 60. Continuing, the plurality of gaps 75 have a distance 115 as between each of the fingers 65 and each of the adjacent steps 70 that is about 65% to 70% of the finger thickness 90 that is perpendicular to the lengthwise axis 60. On the sheet cutting apparatus 50 the preferred finger thickness 90 is about one point two-five (1.25) millimeters wherein the gap distance 115 results being at about sixty-five (65) to seventy (70) percent of the finger thickness 90 would equal about zero point eight-one (0.81) to zero point eight-eight (0.88) millimeters for the gap distance 115. Also, the ascending 95 gaps 75 and the descending 105 gaps 75 all ascend 100 and descend 110 in equal increments. In addition, the increments being both a ascending 100 and descending 110 are at about one point one-five (1.15) to one point two (1.2) times the gap 75 distance 115, being operational to further form the tortuous path 80 for the sheet material 250, as that shown in FIG. 11. Thus the increments, would be preferably about zero point nine-three (0.93) to about one point zero-six (1.06) millimeters for each of both of the ascending increments 100 and descending increments 110. Also, there is a transition as between the increments to one another that is configured as a radius 120 that is equal to the increment being both the ascending increment 100 and the descending increment 110, which preferably would be about zero point nine-three (0.93) to about one point zero-six (1.06) millimeters for the radius 120.

Referring back to FIG. 4, and looking at particular at each of the plurality of fingers 65, each finger 65 has an extension 130 that terminates 135 at the finger thickness 90 wherein a corner is formed that has a corner radius 125 of about one third (⅓) of the gap distance 115. The extension 130 is preferably about six point nine-six (6.96) millimeters at its longest and thus reducing by the amount of the previously discussed ascending increments 100 for the shorter extensions 130. Further, preferably the corner radius 125 is about zero point two-six (0.26) millimeters to about zero point two-nine (0.29) millimeters for the corner radius 125. Further shown in FIG. 4 is the first void distance 91 that is preferably about two point six-seven (2.67) millimeters between the plurality of fingers 65 and the second void distance 92 that is preferably about two (2.00) millimeters between the plurality of fingers 65. Note that in looking at FIG. 4, dimensions not specifically identified are assumed to be equal to their symmetric counterparts that are identified. Wherein other dimensions than those specified could be used that meet the functional objects as described for the sheet cutting apparatus 50.

Returning to the means 155 for cutting as those shown in FIGS. 2, 4, and 5, the means 155 for cutting is preferably constructed of a blade 160 that has a cutting edge 165 that is angled 170 to drive the sheet material 250 in the ascending direction, see also FIG. 11. Preferably, for the materials of construction of the blade 160 would be conventional steel or stainless steel and the cutting edge 165 similar to a razor blade, with the angle 170 being preferably about forty-five (45) degrees. Note that for the means 155 for cutting, structure other than a blade 160 with the cutting edge 165 that is angled 170 could be utilized and further other materials of construction could be utilized that would be considered functional equivalence for cutting 175 the sheet of material 250. Note also that the means 155 as disposed within the dynamic housing 55 is substantially protected from a user coming into contact with the means 155 for cutting enhancing the safety of the sheet cutting apparatus 50. Note, however, that the means 155 for cutting is completely independent from the tortuous path 80 that makes the sheet 250 taut 255, thus the means 155 for cutting is not required for sheet 250 being taut 255, as the sheet 250 is taut 255 prior to coming in contact with the means 155 for cutting, as best shown in FIG. 5, noting that the axial sheet 250 taut 255 tortuous path 80 is at length 260 prior to coming in contact with the means 155 for cutting, as being distinguished from most paper cutters that utilize the cutting blade to tension the paper for cutting. Wherein the paper tension from using the cutting blade would be unreliable due to the blade sharpness changes and paper strength. Thus as opposed to the present invention wherein the sheet 250 taut 255 value is more consistent as being based upon a fixed tortuous path 80 as previously described.

Further, the sheet cutting apparatus 50 can include in addition to the dynamic housing 55 a static beam 185 that includes a longwise axis 190 with a first face portion 195 and an oppositely disposed second face portion 200, also the static beam 185 includes a channel portion 205 that is coaxial with the longwise axis 190 that as disposed in the first phase portion 195. In addition, the static beam 185 includes a plurality of shoulders to 210 that are evenly disposed on the first face portion 195, wherein the plurality of shoulders to 210 are disposed on opposite sides of the channel 205 thus forming ridges to 215 that are substantially parallel to the longwise axis 190. The preferred materials of construction for the static beam 185 are extruded plastic, extruded aluminum, rolled or formed tin, and other lightweight metals, or any suitable alternative.

The dynamic housing 55 is as previously described and the means 155 for cutting is as previously described, except that the dynamic housing 55 is further slidably engaged 220 to the static beam 185 such that the longwise axis 190 and the lengthwise axis 60 are coaxial. Further, the slidable movement 225 of the dynamic housing 55 relative to the static beam 185 is along the longwise axis 190 and the lengthwise axis 60, as best shown in FIGS. 8, 9, and 10.

Further refinements to the dynamic housing 55 for the slidable engagement 220 to the static beam 185 are for the dynamic housing to further include a neck member 140 and a head portion 145 that extend from the exterior 150 of the dynamic housing 55, as best shown in FIGS. 4 and 8. Wherein the neck member 140 and the head portion 145 of the dynamic housing 55 dynamically engage the channel portion 205 and the plurality of shoulders 210 respectively. Wherein, the dynamic housing 55 can rotationally move 240 about the rotational axis 235 that is oriented perpendicular to the lengthwise axis 60, thereby with the ability to accommodate a nonlinear cutting path 180 in the sheet of material 250 via selectively altering a movement path 245 of the dynamic housing 55, as best shown in FIG. 12.

### Method of Use

Referring on particular to FIGS. 10, 11, and 12 which would be termed to use Figures, show basically the two operational modes for the sheet cutting apparatus 50, wherein FIG. 11 specifically would apply to both operational modes. The first operational mode for the sheet cutting apparatus 50 is where the dynamic housing 55 is used solely with the sheet of material 250 as best shown when in FIG. 12, (without the static beam 185) wherein the dynamic housing 55 through its movement path 245 has complete movement path 245 freedom especially to effectuate a non-linear cutting path 180 through the sheet material 250 via either moving along the lengthwise axis 60 and/or having rotational movement 240 about the rotational axis 235 to again have a nonlinear cutting path 180 through the sheet material 250.

The second operational mode for the sheet cutting apparatus 50 in looking in particular at FIG. 10 is where the dynamic housing 55 has the slidable engagement 220 with the static beam 185. This gives the dynamic housing 55 more precise guidance for the movement path 245 to enable a user to execute a more precise cut 175 through the sheet material 250, whether that movement path 245 is linear and, or nonlinear 180, or rotational movement 240. Note that the static beam 185 does not in any way contact with the sheet material 250 in the vicinity of the dynamic housing 55, as the static beam 185 is a guide for the dynamic housing 55 along with its movement path 245, wherein the sheet of material 250 is not constrained to being disposed within the channel 205.

### Conclusion

Accordingly, the present invention of a sheet cutting apparatus 50 has been described with some degree of particularity directed to the embodiments of the present invention. It should be appreciated, though, that the present invention is defined by the following claims construed in light of the prior art so modifications the changes may be made to the exemplary embodiments of the present invention without departing from the inventive concepts contained therein.

1. A sheet cutting apparatus, for cutting a sheet of material comprising:
(a) a dynamic housing having a lengthwise axis wherein a plurality of fingers project therefrom, wherein said fingers are positioned substantially parallel to said lengthwise axis, further included in said dynamic housing is a plurality of steps that are oppositely disposed from said plurality of fingers, wherein each of said plurality of fingers and each of said plurality of steps are adjacent to one another forming a plurality of gaps, wherein each of said plurality of gaps being sized and configured to dynamically allow the sheet of material therethrough, while creating a tortuous path for the sheet of material perpendicular to said lengthwise axis, wherein operationally said plurality of gaps act to keep a portion of the sheet of material substantially taut in-between each of said plurality of gaps; and
(b) a means for cutting disposed within said dynamic housing along said lengthwise axis, further said means for cutting is disposed such that said plurality of fingers and said plurality of steps are evenly disposed on opposite sides of said means, wherein operationally, the portion of the sheet material substantially taut is to be cut via said means for cutting that cuts through the sheet material substantially along said lengthwise axis with the ability to accommodate a non-linear cutting path in the sheet of material via selectably altering a movement path of said dynamic housing.

2. A sheet cutting apparatus, for cutting a sheet of material according to claim 1, wherein said gaps are ascending on one side of said means for cutting and said gaps are descending on an opposing side of said means for cutting, wherein said ascending and descending gaps are in relation to said lengthwise axis.

3. A sheet cutting apparatus, for cutting a sheet of material according to claim 2, wherein each of said gaps have a distance as between each of said finger and said step being adjacent that is about sixty-five (65) to seventy (70) percent of a finger thickness that is perpendicular to said lengthwise axis.

4. A sheet cutting apparatus, for cutting a sheet of material according to claim 3, wherein said ascending gaps and said descending gaps all ascend and descend in equal increments.

5. A sheet cutting apparatus, for cutting a sheet of material according to claim 4, wherein said increments are about one point one-five (1.15) to one point two (1.20) times said gap distance to further form said tortuous path for the sheet of material.

6. A sheet cutting apparatus, for cutting a sheet of material according to claim 5, wherein said increments transition to one another via a radius equaling said increment.

7. A sheet cutting apparatus, for cutting a sheet of material according to claim 6 wherein each said finger has an extension terminating at said finger thickness forming a corner that has a radius of about one-third (⅓) of said gap distance, wherein operationally said tortuous path maintains said taut condition of the sheet of material at about one-third (⅓) of a tensile yield stress of the sheet material irrespective of said means for cutting.

8. A sheet cutting apparatus, for cutting a sheet of material according to claim 7 wherein said means for cutting is constructed of a blade that has a cutting edge that is angled to drive the sheet of material in said ascending direction.

9. A sheet cutting apparatus, for cutting a sheet of material comprising:
(a) a static beam having a longwise axis with a first face portion, an oppositely disposed second face portion, and a channel portion coaxial with said longwise axis that is disposed in said first face portion, also included is a plurality of shoulders evenly disposed on said first face portion on opposite sides of said channel forming ridges substantially parallel to said longwise axis;
(b) a dynamic housing having a lengthwise axis wherein a plurality of fingers project therefrom, wherein said fingers are positioned substantially parallel to said lengthwise axis, further included in said dynamic housing is a plurality of steps that are oppositely disposed from said plurality of fingers, wherein each of said plurality of fingers and each of said plurality of steps are adjacent to one another forming a plurality of gaps, wherein each of said plurality of gaps being sized and configured to dynamically allow the sheet of material therethrough, while creating a tortuous path for the sheet of material perpendicular to said lengthwise axis, said dynamic housing is further slidably engaged to said static beam such that said longwise axis and said lengthwise axis are co-axial, and slidable movement of said dynamic housing relative to said static beam is along said longwise axis and said lengthwise axis, wherein operationally said plurality of gaps act to keep a portion of the sheet of material substantially taut in-between each of said plurality of gaps; and
(c) a means for cutting disposed within said dynamic housing along said lengthwise axis, further said means for cutting is disposed such that said plurality of fingers and said plurality of steps are evenly disposed on opposite sides of said means, wherein operationally, the portion of the sheet material substantially taut is to be cut via said means for cutting that cuts through the sheet material substantially along said lengthwise axis.

10. A sheet cutting apparatus, for cutting a sheet of material according to claim 9, wherein said dynamic housing further includes a neck member terminating a head portion that extends from an exterior portion of said dynamic housing, wherein said neck member and said head portion dynamically engage said channel portion and said plurality of shoulders respectively, wherein operationally said dynamic housing can rotationally move about a rotational axis oriented perpendicular to said lengthwise axis, thereby with the ability to accommodate a non-linear cutting path in the sheet of material via selectably altering a movement path of said dynamic housing.

11. A sheet cutting apparatus, for cutting a sheet of material according to claim 9, wherein said gaps are ascending on one side of said means for cutting and said gaps are descending on an opposing side of said means for cutting, wherein said ascending and descending gaps are in relation to said lengthwise axis.

12. A sheet cutting apparatus, for cutting a sheet of material according to claim 11, wherein each of said gaps have a distance as between each of said finger and said step being adjacent that is about sixty-five (65) to seventy (70) percent of a finger thickness that is perpendicular to said lengthwise axis.

13. A sheet cutting apparatus, for cutting a sheet of material according to claim 12, wherein said ascending gaps and said descending gaps all ascend and descend in equal increments.

14. A sheet cutting apparatus, for cutting a sheet of material according to claim 13, wherein said increments are about one point one-five (1.15) to one point two (1.20) times said gap distance to further form said tortuous path for the sheet of material.

15. A sheet cutting apparatus, for cutting a sheet of material according to claim 14, wherein said increments transition to one another via a radius equaling said increment.

16. A sheet cutting apparatus, for cutting a sheet of material according to claim 15 wherein each said finger has an extension terminating at said finger thickness forming a corner that has a radius of about one-third (⅓) of said gap distance, wherein operationally said tortuous path maintains said taut condition of the sheet of material at about one-third (⅓) of a tensile yield stress of the sheet material irrespective of said means for cutting.

17. A sheet cutting apparatus, for cutting a sheet of material according to claim 16 wherein said means for cutting is constructed of a blade that has a cutting edge that is angled to drive the sheet of material in said ascending direction.
